(19) United States
(12) Patent Application Publication
(10) Pub. No.: US 2017/0061586 A1
(43) Pub. Date: Mar. 2, 2017

(54) METHOD, APPARATUS AND COMPUTER PROGRAM PRODUCT FOR MOTION DEBLURRING OF IMAGE FRAMES

(71) Applicant: Nokia Technologies Oy, Espoo (FI)

(72) Inventors: Mithun Uliyar, Bangalore (IN); Gururaj Putraya, Bangalore (IN); Krishna Govindarao, Bangalore (IN)

(21) Appl. No.: 15/248,532

(22) Filed: Aug. 26, 2016

(30) Foreign Application Priority Data
Aug. 28, 2015 (IN) 4537/CHE/2015

(51) Int. Cl. G06T 5/00; H04N 5/217

(52) U.S. Cl. CPC G06T 5/003; H04N 5/217; G06T 2207/20201; G06T 2207/10024

(57) ABSTRACT

In an example embodiment a method, apparatus and computer program product are provided. The method includes causing a screening element in a camera to block wavelengths associated with at least one color in incident light at pre-defined time intervals during an image frame capture. A motion blur is removed from the captured image frame for the at least one color based on the blocking of the wavelengths associated with the at least one color. The method further includes generating a motion deblurred image frame using the captured image frame with the motion blur removed for the at least one color.

### TECHNICAL FIELD

Various embodiments, relate generally to method, apparatus, and computer program product for motion deblurring of image frames.

### BACKGROUND

Typically, motion artifacts are observed in a captured image frame when an exposure time associated with the image frame capture is significantly large and a scene being captured in the image frame involves objects in motion, such as walking/running people, moving cars etc. The presence of motion artifacts, which are observed in form of blurring of objects associated with motion, degrades a quality of the captured image frame. To reduce motion blur, many conventional mechanisms propose a flutter shutter technique, i.e. a technique involving opening and closing of an aperture or a shutter of the camera, several times during the exposure time. Such a process of opening and closing the shutter preserves high frequency content of an object that is moving in the scene, which makes it is possible to reconstruct a sharp image frame from a blurred image frame. However, such a technique involves closing the aperture of the camera for almost half of the exposure time and as a result, a light throughput is significantly reduced and an output quality of the captured image frame is not as good as a normally captured image frame. Moreover, such a low light or a reduced light capture of the image frame also introduces several noise and color related artifacts in the captured image frame.

### SUMMARY OF SOME EMBODIMENTS

Various example embodiments are set out in the claims.

In a first embodiment, there is provided a method comprising: causing a screening element in a camera to block wavelengths associated with at least one color in incident light at pre-defined time intervals during an image frame capture; removing motion blur from the captured image frame for the at least one color based on the blocking of the wavelengths associated with the at least one color; and generating a motion deblurred image frame using the captured image frame with the motion blur removed for the at least one color.

In a second embodiment, there is provided an apparatus comprising: at least one processor; and at least one memory comprising computer program code, the at least one memory and the computer program code configured to, with the at least one processor, cause the apparatus to at least perform: cause a screening element in a camera to block wavelengths associated with at least one color in incident light at pre-defined time intervals during an image frame capture; remove motion blur from the captured image frame for the at least one color based on the blocking of the wavelengths associated with the at least one color; and generate a motion deblurred image frame using the captured image frame with the motion blur removed for the at least one color.

In a third embodiment, there is provided an apparatus comprising: a sensor comprising a plurality of sensing elements; at least one lens configured to direct incident light towards the sensor, each sensing element in the sensor configured to sense, in the incident light, a color from among a plurality of colors associated with a pre-defined color space; a display panel disposed in a path traveled by the incident light from the at least one lens to the sensor, the display panel comprising a plurality of pixels in proportion to the plurality of sensing elements of the sensor; at least one processor; and at least one memory comprising computer program code, the at least one memory and the computer program code configured to, with the at least one processor, cause the apparatus to at least perform: cause blocking of wavelengths associated with at least one color in the incident light at pre-defined time intervals during an image frame capture by periodically switching ON and OFF a receptivity to the incident light of one or more pixels from among the plurality of pixels during the image frame capture, the one or more pixels related to sensing elements associated with sensing of the at least one color from among the plurality of colors; remove motion blur from the captured image frame for the at least one color based on the blocking of the wavelengths associated with the at least one color; and generate a motion deblurred image frame using the captured image frame with the motion blur removed for the at least one color.

In a fourth embodiment, there is provided an apparatus comprising: a sensor comprising a plurality of sensing elements; at least one lens configured to direct incident light towards the sensor, each sensing element in the sensor configured to sense, in the incident light, a color from among a plurality of colors associated with a pre-defined color space; a wavelength bandpass filter disposed in front of the at least one lens, the wavelength bandpass filter configured to block wavelengths associated with at least one color from among the plurality of colors in the incident light; at least one processor; and at least one memory comprising computer program code, the at least one memory and the computer program code configured to, with the at least one processor, cause the apparatus to at least perform: cause blocking of the wavelengths associated with the at least one color in the incident light at pre-defined time intervals during an image frame capture by periodically placing the wavelength bandpass filter in a path of the incident light and retracting the wavelength bandpass filter from the path of the incident light during the image frame capture; remove motion blur from the captured image frame for the at least one color based on the blocking of the wavelengths associated with the at least one color; and generate a motion deblurred image frame using the captured image frame with the motion blur removed for the at least one color.

In a fifth embodiment, there is provided a computer program product comprising at least one computer-readable storage medium, the computer-readable storage medium comprising a set of instructions, which, when executed by one or more processors, cause an apparatus to at least perform: cause a screening element in a camera to block wavelengths associated with at least one color in incident light at pre-defined time intervals during image frame capture; remove motion blur from the captured image frame for the at least one color based on the blocking of the wavelengths associated with the at least one color; and generate a motion deblurred image frame using the captured image frame with the motion blur removed for the at least one color.

In a sixth embodiment, there is provided an apparatus comprising: means for causing a screening element in a camera to block wavelengths associated with at least one color in incident light at pre-defined time intervals during an image frame capture; means for removing motion blur from the captured image frame for the at least one color based on the blocking of the wavelengths associated with the at least one color; and means for generating a motion deblurred image frame using the captured image frame with the motion blur removed for the at least one color.

In a seventh embodiment, there is provided a computer program comprising program instructions which when executed by an apparatus, cause the apparatus to: cause a screening element in a camera to block wavelengths associated with at least one color in incident light at pre-defined time intervals during an image frame capture; remove motion blur from the captured image frame for the at least one color based on the blocking of the wavelengths associated with the at least one color; and generate a motion deblurred image frame using the captured image frame with the motion blur removed for the at least one color.

### BRIEF DESCRIPTION OF THE FIGURES

Various embodiments are illustrated by way of example, and not by way of limitation, in the figures of the accompanying drawings in which:

FIG. 1 illustrates a device in accordance with an example embodiment;

FIG. 2 illustrates an apparatus for motion deblurring of image frames, in accordance with an example embodiment;

FIG. 3 depicts a simplified arrangement of components of a camera, in accordance with an example embodiment;

FIG. 4 depicts an example representation of a sensor including sensing elements configured to sense colors from a RGB color space in incident light, in accordance with an example embodiment;

FIG. 5 depicts a simplified arrangement of components of the camera, in accordance with another example embodiment;

FIGS. 6A-6B depict bandpass characteristic plots of the camera when the wavelength bandpass filter is retracted from and placed in the path of the incident light during the image frame capture, respectively, in accordance with an example embodiment;

FIG. 7 is a flowchart depicting an example method for motion deblurring of image frames, in accordance with an example embodiment;

FIG. 8 is a flowchart depicting an example method for motion deblurring of image frames, in accordance with another example embodiment; and

FIG. 9 is a flowchart depicting an example method for motion deblurring of image frames, in accordance with yet another example embodiment.

### DETAILED DESCRIPTION

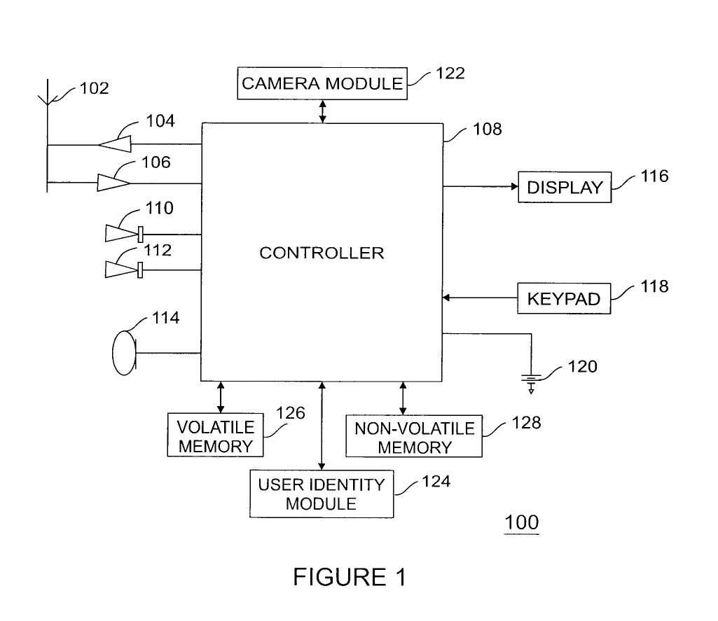

Example embodiments and their potential effects are understood by referring to FIGS. 1 through 9 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communication devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as Bluetooth® networks, Zigbee® networks, Institute of Electric and Electronic Engineers (IEEE) 802.11x networks, and the like; and wireline telecommunication networks such as public switched telephone network (PSTN) and the like.

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes at least one media capturing element, such as a camera, video and/or audio module, in communication with the controller 108. The media capturing element may be any means configured for capturing an image frame, video and/or audio for storage, for display or for transmission. In an example embodiment in which the media capturing element is a camera module 122, the camera module 122 may include at least one camera capable of forming a digital image file from a captured image frame. As such, the camera module 122 includes all hardware, such as a lens or other optical component(s), and software for creating a digital image file from a captured image frame. Alternatively, the camera module 122 may include the hardware needed to view an image frame, while a memory device of the device 100 stores instructions for execution by the controller 108 in the form of software to create a digital image file from a captured image frame. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively include an electrically erasable programmable read only memory (EEPROM), flash memory, hard drive, or the like. The memories may store any number of pieces of information, and data, used by the device 100 to implement the functions of the device 100.

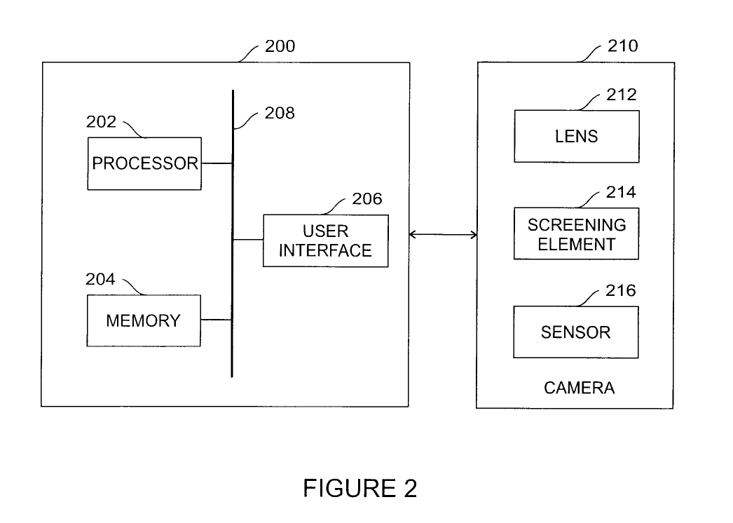

FIG. 2 illustrates an apparatus 200 for motion deblurring of image frames, in accordance with an example embodiment. The term ‘motion deblurring of image frames’ as used herein refers to removal of motion blur from captured image frames. The motion blur is typically introduced on account of relative motion between an image capture element and an object being captured. The relative motion may be on account of moving objects in a scene being captured by a steady camera or from an unsteady camera capturing a fairly still object.

The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. Moreover, various embodiments may be embodied wholly at a single device, for example, the device 100 or in a combination of devices. Furthermore, it should be noted that the devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory include, but are not limited to, random access memory, dynamic random access memory, static random access memory, and the like. Some examples of the non-volatile memory include, but are not limited to, hard disk drive, magnetic tape, optical disk, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments described herein. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

In an example embodiment, the apparatus 200 includes a user interface 206 configured to be in communication with the processor 202. Examples of the user interface 206 include, but are not limited to, an input interface and/or an output user interface. The input interface is configured to receive an indication of a user input. The output user interface provides an audible, a visual, a mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal display, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, a keyboard, touch screen, or the like. In this regard, for example, the processor 202 may comprise a user interface circuitry configured to control at least some functions of one or more elements of the user interface 206, such as, for example, a speaker, ringer, microphone, display, and/or the like. The processor 202 and/or the user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device may include a computing device, a media-capturing device, a communication device and/or any combinations thereof. Some examples of the computing device may include a laptop, a tablet computer, a personal digital assistant (PDA), a wearable device and the like. Some examples of the communication device may include a mobile phone, a Smartphone and the like. Some examples of the media-capturing device may include a camera, a surveillance device and the like. In an example embodiment, the electronic device may include a user interface, for example, the UI 206, having user interface circuitry and user interface software configured to facilitate a user to control at least one function of the electronic device through use of a display and further configured to respond to user inputs. In an example embodiment, the electronic device may include a display circuitry configured to display at least a portion of the user interface of the electronic device. The display and display circuitry may be configured to facilitate the user to control at least one function of the electronic device.

In an example embodiment, the electronic device may include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus 200 or circuitry to perform the functions of the transceiver. The transceiver may be configured to receive media content. Examples of media content may include audio content, video content, data, and a combination thereof.

These components (202-206) may communicate with each other via a centralized circuit system 208 to generate motion deblurred image frames. The centralized circuit system 208 may be various devices configured to, among other things, provide or enable communication between the components (202-206) of the apparatus 200. In certain embodiments, the centralized circuit system 208 may be a central printed circuit board (PCB) such as a motherboard, main board, system board, or logic board. The centralized circuit system 208 may also, or alternatively, include other printed circuit assemblies (PCAs) or communication channel media.

In an embodiment, the apparatus 200 is in operative communication with a camera 210. In an example embodiment, the camera 210 is a digital camera. In some embodiments, the camera 210 may be external to the apparatus 200, though it maybe included within the electronic device. In some embodiments, the camera 210 may be disposed external to the electronic device and may be operatively coupled to the apparatus 200. It should be noted that though the apparatus 200 is caused to be in operative communication with the camera 210 in FIG. 2, in some embodiments, the camera 210 may be configured to be included in the apparatus 200.

The camera 210 is configured to facilitate capturing of digital image frames and videos. To that effect, the camera 210 includes at least one lens, such as a lens 212, a screening element 214 and a sensor 216. In some embodiments, the camera 210 may further include other imaging circuitries and/or software, which in combination, may be an example of the camera module 122 of the device 100.

In an example embodiment, in order to capture an image frame or a video of a scene, the apparatus 200 may be caused to open an aperture of the camera 210 for a pre-defined time period (i.e. the exposure time) for enabling light reflected from one or more objects in the scene to be incident on the lens 212. The lens 212 may be configured to direct the incident light towards the sensor 216 for sensing one or more colors in the incident light. In an example embodiment, the sensor 216 includes a plurality of sensing elements with each sensing element configured to sense a color associated with a pre-defined color space in the incident light. In some example implementations of the sensor 216, a color filter array (CFA) like a Bayer filter, may be disposed on the sensor 216 to enable each sensing element to sense a color in a pre-defined color space, such as for example, a red-green-blue (RGB) color space. Accordingly, each sensing element may be configured to sense a red color, a green color or a blue color. In some embodiments, the pre-defined color space is a cyan-magenta-yellow (CMY) color space or a cyan-magenta-yellow-black (CMYK) color space. In such a scenario, each sensing element may be configured to sense one of a cyan, magenta, yellow or black color.

In an embodiment, the processor 202 is configured to, with the content of the memory 204, and optionally with other components described herein, to cause the screening element 214 in the camera 210 to block wavelengths associated with at least one color in the incident light at pre-defined time intervals during an image frame capture. The blocking of the wavelengths at the pre-defined time intervals may be performed based on a pre-determined code or a pattern. For example, the blocking of wavelengths at pre-defined time intervals may be performed by the screening element 214 with respect to a following pattern: “1010000111000001010000110011110111010111001001100111”, where ‘1’ corresponds to an unblock or an open configuration and ‘0’ corresponding to a block configuration of the screening element 214. It is understood that numerical values/patterns for operation of the screening element 214 are provided herein for example purposes and that various such patterns may be chosen for obtaining optimal motion deblurring of captured image frames. In an illustrative scenario, as the incident light corresponding to a scene being captured by the camera 210 travels towards the sensor 216, a color, for example a red color may be periodically blocked during the entire duration of the image frame capture by the screening element 214. In other words, a ‘flutter-shutter’ effect is created only for one wavelength, i.e. the wavelength corresponding to say, red color, during the image frame capture by the screening element 214. In some embodiments, on account of the flutter-shutter effect, high frequency content related to one or more moving objects in the scene is retained in the red color. The term ‘high frequency content’ as used herein refers to imaging information related to moving objects without any motion artifacts typically associated with moving objects in captured image frames. Generally, for improving a quality of the captured image frame, an exposure time for image frame capture is increased to increase the light throughput. However, if there are one or more moving objects in the scene being captured, such as for example a flock of flying birds, a speeding car, fireworks in the sky and the like, then a long exposure to a moving object causes distortion in the captured image frame on account of relative motion between the camera 210 and the moving object. For example, a moving vehicle may appear distorted with its edges fuzzy or unclear in the captured image frame. The ‘flutter-shutter’ effect entails short exposures to the moving object thereby facilitating retaining of details, such as for example edge information, of the moving object without the accompanying distortion or related motion artifacts. Such imaging information of the one or more moving objects in the scene is referred to herein as ‘high frequency content’. In some embodiments, on account of retaining the high frequency content in the red color, the imaging information in the red color has sharp or un-blurred imaging information, whereas the imaging information captured in other colors, for example the green and the blue color, may include blurred imaging information.

It is understood that the ‘flutter-shutter’ effect is explained herein with respect to the red color for illustration purposes. However, it is noted that such blocking of wavelengths may be performed for wavelengths corresponding to other colors, such as the green color or the blue color. Moreover, in some embodiments, the ‘flutter-shutter’ effect may be performed for more than one wavelength, such as for example the wavelengths related to the red color and the green color. However, it is understood that performing such periodic blocking of wavelengths for more than one wavelength may affect a light throughput observed in the captured image frame and appropriate adjustments may then have to be made during image frame reconstruction. In an example embodiment, a processing means may be configured to cause the screening element 214 in the camera 210 to block wavelengths associated with at least one color in the incident light at pre-defined time intervals during an image frame capture. An example of the processing means may include the processor 202, which may be an example of the controller 108.

In an example embodiment, the processor 202 is configured to, with the content of the memory 204, and optionally with other components described herein, to cause the apparatus 200 to remove motion blur from the captured image frame for the at least one color based on the blocking of the wavelengths associated with the at least one color. For example, if a green color in the incident light is subjected to the ‘flutter-shutter’ effect by the screening element 214, then the apparatus 200 may be caused to remove motion blur from the captured image frame for the green color. In some embodiments, the apparatus 200 is caused to perform a deconvolution of the captured image frame in, say the green color, for removing the motion blur. The deconvolution of the image frame is further explained with reference to the following illustrative example.

As explained above, a relative motion between an imaging system (for example the camera 210), and the object being captured introduces a blurring effect, which distorts the details in the captured image frame. In an example embodiment, the path traveled by the light ray or the incident light (corresponding to the scene being captured) may be considered to be optically perfect and convolved with a point-spread function (PSF) to produce the captured image frame. The PSF is a mathematical function that describes the output of an imaging system for an input point source. More specifically, the PSF describes a distortion that a theoretical point source of light experiences on account of traveling along the optical path in the imaging system. In an example embodiment, blind deconvolution methods may be utilized to estimate the PSF from a blurred image frame and use the PSF to deconvolve the captured image frame. These methods include well-known algorithms such as Richardson Lucy and Wiener deconvolution.

The Richardson-Lucy algorithm is an iterative deconvolution algorithm derived from Bayes theorem that minimizes the following estimation error:

$$arg {min}_{I} n ( {‖ {I}_{b} - I ⊗ K ‖}^{2} )$$

where I is the deblurred image frame, K is the blur function, I_{b} is the observed blur image frame, and n(.) is the noise distribution. A solution can be obtained using an iterative update algorithm defined as follows:

$${I}^{t + 1} = {I}^{t} \times K * \frac{{I}_{b}}{{I}^{t} ⊗ K}$$

where * is the correlation operation. A blind deconvolution algorithm using the Richardson-Lucy algorithm iteratively optimizes I and K in alternation.

In an example embodiment, a least-square estimation may be utilized to obtain the deblurred image frame as follows:

A=X⁻¹B

Where B is the captured image frame, A is the motion deblurred image frame and X is the blur function. A pseudo-inverse X⁻¹ of the estimated blur function X may be computed in the least squares sense and may be used to obtain the deblurred image frame. More specifically, the pre-determined code or pattern for causing the flutter-shutter effect may be chosen in such a manner that the motion blur (as embodied by the blur function) be reduced to a negligible value. In the physical sense, the high frequency content retained on account of the ‘flutter-shutter’ effect is configured to facilitate the removal of the motion blur in the captured image frame. More specifically, deconvolving of a blurred image frame without the high frequency content may generate undesirable ringing artifacts in the deblurred image frame. Accordingly, the preserved high frequency content assists in efficiently removing the motion blur from the captured image frame. It is noted that the removal of motion blur is performed for the captured image frame for only that color, which is associated with the ‘flutter-shutter’ effect as the high frequency content is retained for that color only. In an example embodiment, a processing means may be configured to remove motion blur from the captured image frame for the at least one color based on the blocking of the wavelengths associated with the at least one color. An example of the processing means may include the processor 202, which may be an example of the controller 108.

In an example embodiment, the processor 202 is configured to, with the content of the memory 204, and optionally with other components described herein, to cause the apparatus 200 to generate a motion deblurred image frame using the captured image frame with the motion blur removed for the at least one color. In an illustrative example, if the captured image frame is associated with removed motion blur in say, blue color, then the imaging information related to such a captured image frame may be utilized to generate a motion deblurred image frame in all colors associated with the captured image frame. To that effect, in some embodiments, the apparatus 200 may be caused to perform content matching for identifying image patches of the captured image frame in other colors that correspond to each image patch of the captured image frame with removed motion blur in the at least one color. For example, the apparatus 200 may be caused to identify image patches in green and red colors for each image patch of the captured image frame in blue color if the ‘blue color’ is associated with the flutter-shutter effect during the image frame capture. In an example embodiment, the apparatus 200 may be caused to utilize techniques such as normalized cross correlation to match content in image patches across colors. In another example embodiment, the apparatus 200 may be caused to match content in image patches across colors based on spatial relationship between image patches associated with low resolution/frequency content and the image patches associated with high resolution/frequency content. It is understood that image patches associated with low resolution/frequency content are the image patches corresponding to those colors, which were not subjected to the ‘flutter-shutter’ effect, whereas the image patches associated with high resolution/frequency content are the image patches corresponding to the one or more colors, which were subjected to the ‘flutter-shutter’ effect. In some embodiments, the memory 204 is configured to store a training database of low-resolution image patches and the corresponding high-resolution image patches with spatial relationship between the patches based on a Markov network model. In such a scenario, the apparatus 200 may be caused to identify an image patch with low frequency content corresponding to the image patch with high frequency content using the training database of patches and the spatial relationships stored therein.

In an embodiment, the apparatus 200 is caused to transfer ‘sharpness’ from the each image patch in the at least one color to the corresponding image patches in the other colors. The term ‘sharpness’ as used herein refers to un-blurred or undistorted imaging information, such as information related to object edges etc. obtained subsequent to removal of motion blur in the at least one color. For example, if the ‘blue color’ is associated with the flutter-shutter effect during the image frame capture, then image patches in green and red colors for each image patch of the captured image frame in blue color may first be identified and then a sharpness of the blue color (on account of motion blur removal explained above) may be transferred to the green and red colors in order to generate the motion deblurred image frame. In order to transfer sharpness from one color, referred to herein as sharp channel, to other colors, i.e. blurred channels, in some embodiments, the apparatus 200 may be caused to generate a depth map from the sensed information obtained from the sensor 216. The depth map may then be used to determine object distances in the scene. Further, the range of object distances can be segmented into two or more coarse sub-ranges where filtering parameters can be chosen as constants. One or more digital filters may then be applied to sub-ranges to restore sharpness to all color channels. In some embodiments, the correction of the blurred color channel(s) may be performed by just copying high frequencies of the sharpest color channel to the blurred channels. In some embodiments, a high pass filter with suitable weighting coefficients may be applied to the sharpest color channel and resulting information may be added to each blurred channel. Further, both weighting coefficients and high pass filter coefficients may be predetermined from lens data or prior calibration experiments for various parameters such as position within the image field, object distance, light spectrum, and the like. In an example embodiment, a processing means may be configured to generate a motion deblurred image frame using the captured image frame with the motion blur removed for the at least one color. An example of the processing means may include the processor 202, which may be an example of the controller 108. In at least one embodiment, the UI 206 may be configured to display the motion deblurred image frame on a display screen associated with the apparatus 200.

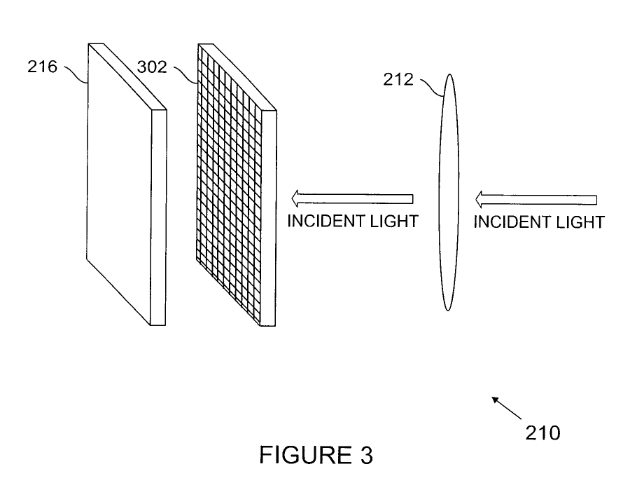

As explained above, the screening element 214 may be caused to block wavelengths of one or more colors in the incident light at pre-defined time intervals to create the flutter-shutter effect. It is understood that the screening element 214 may be embodied in various forms. In one example embodiment, the screening element 214 is a display panel and is disposed in a path traveled by the incident light from the lens 212 to the sensor 216 in the camera 210. Such a configuration of the various components of the camera 210 is explained with reference to FIG. 3.

Referring now to FIG. 3, a simplified arrangement of components of the camera 210 is depicted, in accordance with an example embodiment. As explained above, the camera 210 includes the lens 212, a screening element in form of a display panel 302 and the sensor 216. The camera 210 is depicted herein to include only the lens 212, the display panel 302 and the sensor 216 for illustration purposes. It is understood that the camera 210 may be associated with a plurality of components apart from the lens 212, the display panel 302 and the sensor 216. For example, the camera 210 may include other imaging and processing circuitries. Moreover it is understood that light incident on the lens 212 is directed towards the sensor 216 as depicted in an example manner by “incident light” in FIG. 3. The display panel 302 is disposed in front of the sensor 216 such that light (for example, light reflected from one or more objects in a scene being captured) incident on the lens 212 travels through the display panel 302 before being sensed by the sensor 216.

In an example embodiment, the screening element embodied as the display panel 302 is configured to include a plurality of pixels. Examples of the display panel 302 may include, but are not limited to a liquid crystal display (LCD) panel, light emitting diode (LED) display panel, a thin-film transistor (TFT) display panel, an active-matrix organic light-emitting diode (AMOLED) display panel and the like. In an embodiment, the display panel 302 includes a plurality of pixels in proportion to the plurality of sensing elements of the sensor 216. More specifically, a number of pixels in display panel 302 are substantially equal to the number of sensing elements in the sensor 216. In other words, a pixel resolution of the display panel 302 is substantially equal to a ‘sensing element density’ associated with the sensor 216. As explained with reference to FIG. 2, the screening element 214 is caused to block wavelengths corresponding to at least one color in the incident light at pre-defined intervals during image frame capture. Accordingly, the apparatus 200 is caused to periodically switch ON and OFF a receptivity to the incident light of one or more pixels of the display panel 302 which are related to sensing elements associated with sensing of the at least one color in the sensor 216 for causing the blocking of the wavelengths associated with the at least one color in the incident light. The blocking of the wavelengths is further explained with reference to an illustrative example below.

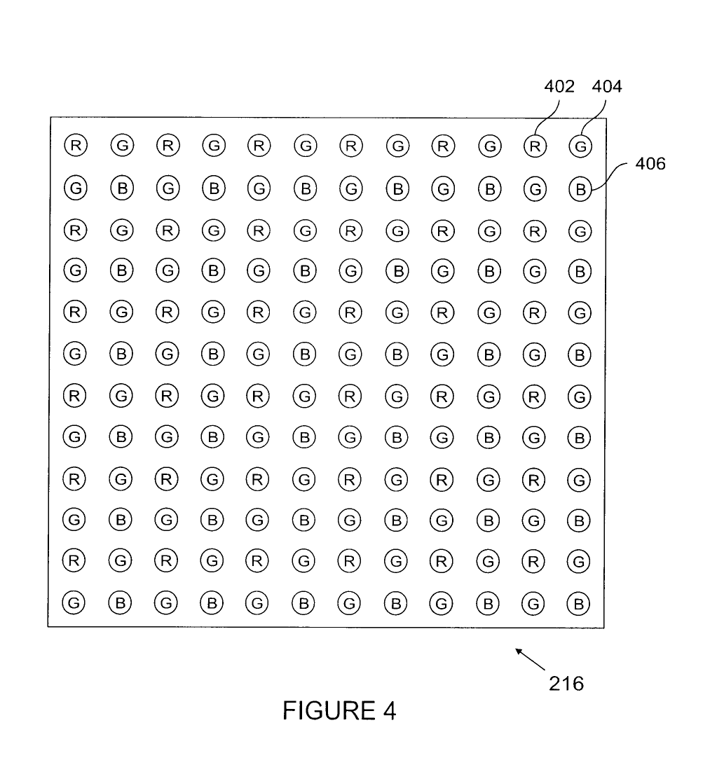

As explained with reference to FIG. 2, the sensor 216 includes a plurality of sensing elements, with each sensing element configured to sense, in the incident light, a color from among a plurality of colors associated with a pre-defined color space. An example representation of such a sensor is depicted in FIG. 4.

Referring now to FIG. 4, an example representation of the sensor 216 including sensing elements configured to sense colors from the RGB color space in the incident light is depicted, in accordance with an example embodiment. The sensor 216 depicts a plurality of sensing elements with each sensing element configured to sense one color from the RGB color space. Accordingly, in FIG. 4, the sensing elements sensing only red color in the incident light are marked as ‘R’, the sensing elements sensing only green color in the incident light are marked as ‘G’ and the sensing elements sensing only blue color in the incident light are marked as ‘B’. For example, the sensing element 402 is configured to sense only red color, the sensing element 404 is configured to sense only green color and the sensing element 406 is configured to sense only blue color. It is understood that the apparatus 200 explained with reference to FIG. 2 may employ known color interpolation techniques to identify other color channels at each sensing element location and further combine them to configure the plurality of colors corresponding to the captured image frame. Some examples of the color interpolation techniques may include, but are not limited to, a bi-linear interpolation, bi-cubic interpolation and spline interpolation.

Referring back to FIG. 3, the display panel 302 may be disposed in front of the sensor 216 with sensing element configuration as explained with reference to FIG. 4. Moreover, since a pixel resolution of the display panel 302 is equal to a sensing element resolution (or density) of the sensor 216, each pixel in the display panel 302 may correspond to one of red, green or a blue color of the sensor 216. During image frame capture, the apparatus 200 may be caused to periodically switch ON and OFF a receptivity of one or more pixels corresponding to at least one color, such as for example green color, to create the ‘flutter-shutter’ effect for the green color. The ON and OFF switching of receptivity of the pixels for wavelengths corresponding to one specific color at pre-defined time intervals causes periodic blocking of wavelengths for that color. As explained with reference to FIG. 2, such periodic blocking of wavelengths may be performed based on a pre-determined code or a pattern with switching interval being in order of milliseconds. The display panel 302, in effect, serves as pixel level shutter configured to open and close receptivity to wavelengths for pixels corresponding to specific color. The periodic blocking of wavelengths enables retention of high frequency content associated with moving objects in a scene being captured. The apparatus 200 may further be caused to remove motion blur from the captured image frame for the color associated with the ‘flutter-shutter’ effect and thereafter transfer sharpness to other colors for image patches with matching content as explained with FIG. 2 to generate the motion deblurred image frame.

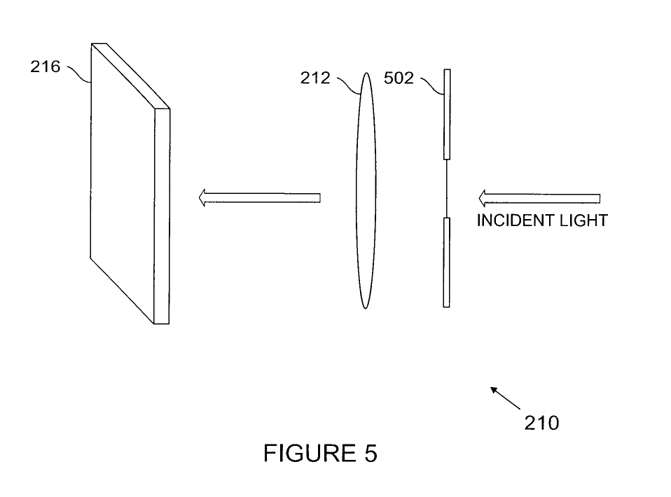

It is understood that the screening element 214 is depicted to be embodied as a display panel (for example, the display panel 302) in FIG. 3 for illustration purposes. It is noted that the screening element 214 may be embodied in various forms for causing a blocking of wavelengths corresponding to at least one color in the incident light. In an embodiment, the screening element 214 may be embodied as a wavelength bandpass filter. Such an embodiment is further explained with reference to example arrangement of the various components of the camera 210 in FIG. 5.

FIG. 5 depicts a simplified arrangement of components of the camera 210, in accordance with another example embodiment. As depicted in FIG. 5, the camera 210 includes the lens 212, a screening element in form of a wavelength bandpass filter 502 and the sensor 216. It is understood that the camera 210 may be associated with a plurality of components apart from the lens 212, the wavelength bandpass filter 502 and the sensor 216. Moreover it is understood that light incident on the lens 212 is directed towards the sensor 216 as depicted in an example manner by “incident light” in FIG. 5.

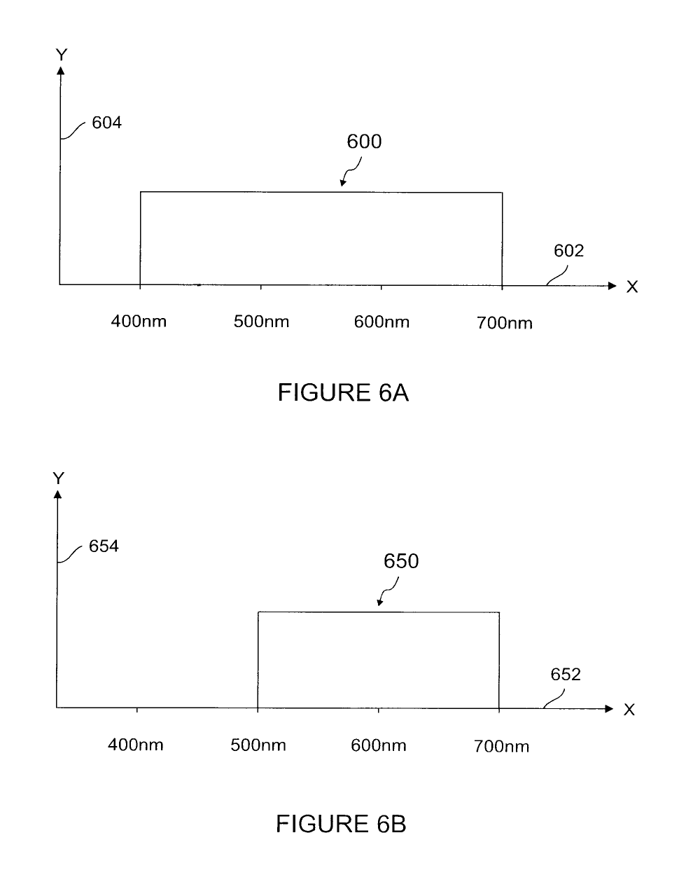

The wavelength bandpass filter 502 is disposed in front of the lens 212 in the camera 210 and is capable of being periodically placed in a path of the incident light and retracted from the path of the incident light during the image frame capture to cause the blocking of the wavelengths at the pre-defined time intervals. The bandpass characteristics of the camera 210 on account of such periodic placing in and retraction from the path of incident light by the wavelength bandpass filter 502 are depicted in FIGS. 6A and 6B.

Referring now to FIG. 6A, a bandpass characteristic plot 600 of the camera 210 when the wavelength bandpass filter 502 is retracted from the path of the incident light during the image frame capture is depicted, in accordance with an example embodiment. The bandpass characteristic plot 600 includes an X-axis 602 representing variation in wavelength of various colors in incident light and an Y-axis 604 representing variation in exposure time. It can be seen that the camera 210 is configured to allow entire range of wavelengths from 400 nanometers (nm) to 700 nm of incident light to pass through for a given exposure time in the retracted position of the wavelength bandpass filter 502. FIG. 6B depicts a bandpass characteristic plot 650 of the camera 210 when the wavelength bandpass filter 502 is placed in the path of the incident light during the image frame capture, in accordance with an example embodiment. The bandpass characteristic plot 650 includes an X-axis 652 representing variation in wavelength of various colors in the incident light and an Y-axis 654 representing variation in exposure time. It can be seen that the camera 210 is configured to allow wavelengths from 500 nm to 700 nm of incident light to pass through for a given exposure time and block wavelengths from 400 nm to 500 nm (i.e. block wavelengths corresponding to blue color and let wavelengths corresponding to the green and the red color to pass through) when the wavelength bandpass filter 502 is placed in the path of the incident light during the image frame capture.

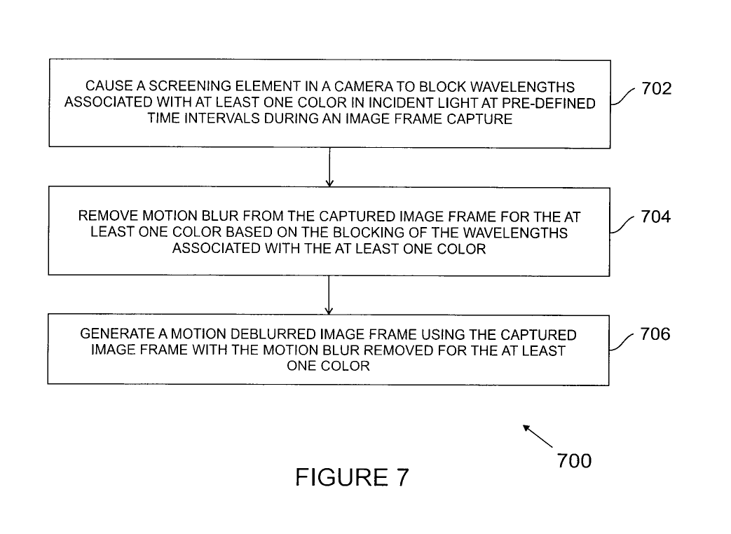

It is understood from the bandpass characteristic plots 600 and 650 that the wavelength bandpass filter 502 upon being periodically placed in and retracted from the path of the incident light during the image frame capture may cause the blocking of the wavelengths corresponding to at least one color in the incident light. Further, the periodic blocking of wavelengths may be performed based on a pre-determined code or a pattern with switching interval being in order of milliseconds. As explained with reference to FIG. 2, the periodic blocking of the wavelengths creates a ‘flutter-shutter’ effect for at least one color, which facilitates in retaining of high frequency content in that one color. The apparatus 200 may further be caused to remove motion blur from the captured image frame for the color associated with the ‘flutter-shutter’ effect and thereafter transfer sharpness to other colors for image patches with matching content as explained with FIG. 2 to generate the motion deblurred image frame. A method for motion deblurring of image frames is explained with reference to FIG. 7.

FIG. 7 is a flowchart depicting an example method 700 for motion deblurring of image frames, in accordance with an example embodiment. The method 700 depicted in the flow chart may be executed by, for example, the apparatus 200 of FIG. 2.

At 702, the method 700 includes causing a screening element in a camera (for example, the screening element 214 of the camera 210) to block wavelengths associated with at least one color in incident light at pre-defined time intervals during an image frame capture. In an illustrative scenario, as the incident light corresponding to a scene being captured by the camera travels towards the sensor, a color, for example a red color may be periodically blocked during the entire duration of the image frame capture by the screening element. In other words, a ‘flutter-shutter’ effect is created only for one wavelength, i.e. the wavelength corresponding to say, red color, during the image frame capture by the screening element. In some embodiments, on account of the flutter-shutter effect, high frequency content related to one or more moving objects in the scene is retained in the red color. The blocking of the wavelengths at the pre-defined time intervals may be performed based on a pre-determined code or a pattern as explained with reference to FIG. 2. For example, the blocking of wavelengths at pre-defined time intervals may be performed by the screening element with respect to a following pattern: “1010000111000001010000110011110111010111001001100111”, where ‘1’ corresponds to an unblock or an open configuration and ‘0’ corresponding to a block configuration of the screening element.

At 704, the method 700 includes removing motion blur from the captured image frame for the at least one color based on the blocking of the wavelengths associated with the at least one color. For example, if a green color in the incident light is subjected to the ‘flutter-shutter’ effect by the screening element, then motion blur from the captured image frame may be removed for the green color. In some embodiments, a deconvolution of the captured image frame may be performed in, say the green color, for removing the motion blur. In an example embodiment, blind deconvolution methods may be utilized to estimate a PSF from a blurred image frame and the PSF may then be used to deconvolve the captured image frame for the color associated with the ‘flutter-shutter’ effect. These methods include well-known algorithms such as Richardson Lucy and Wiener deconvolution. The deconvolution of the image frame may be performed as explained with reference to FIG. 2 and is not explained again herein.

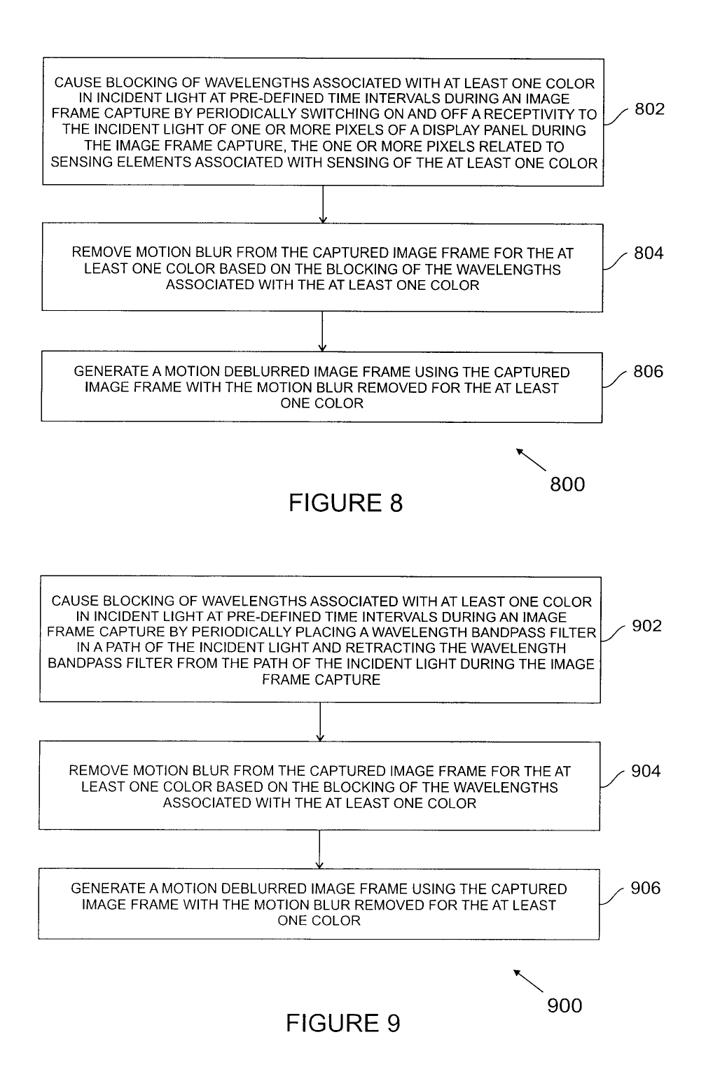

At 706, the method 700 includes generating a motion deblurred image frame using the captured image frame with the motion blur removed for the at least one color. In an illustrative example, if the captured image frame is associated with removed motion blur in say, blue color, then the imaging information related to such a captured image frame may be utilized to generate a motion deblurred image frame in all colors associated with the captured image frame. To that effect, in some embodiments, content matching may be performed for identifying image patches of the captured image frame in other colors that correspond to each image patch of the captured image frame in the at least one color with removed motion blur. For example, image patches in green and red colors for each image patch of the captured image frame in blue color may be identified if the ‘blue color’ is associated with the flutter-shutter effect during the image frame capture. In an example embodiment, techniques such as normalized cross correlation may be utilized to match content in image patches across colors. In another example embodiment, content in image patches across colors may be matched based on spatial relationship between image patches associated with low resolution/frequency content and the image patches associated with high resolution/frequency content as explained with reference to FIG. 2. In an embodiment, sharpness from the each image patch in the at least one color may further be transferred to the corresponding image patches in the other colors to generate the motion deblurred image frame. For example, if the ‘blue color’ is associated with the flutter-shutter effect during the image frame capture, then image patches in green and red colors corresponding to each image patch of the captured image frame in blue color may first be identified and then a sharpness of the blue color (on account of motion blur removal explained above) may be transferred to the matching-in-content image patches in green and red colors in order to generate the motion deblurred image frame. The transferring of sharpness may be performed as explained with reference to FIG. 2 and is not explained again herein. Another method for motion deblurring of image frames is explained with reference to FIG. 8.

FIG. 8 is a flowchart depicting an example method 800 for motion deblurring of image frames, in accordance with another example embodiment. The method 800 depicted in the flow chart may be executed by, for example, the apparatus 200 of FIG. 2.

At 802, the method 800 includes causing blocking of wavelengths associated with at least one color in incident light at pre-defined time intervals during an image frame capture by periodically switching ON and OFF a receptivity to the incident light of one or more pixels from among the plurality of pixels of a display panel during the image frame capture. The one or more pixels are related to sensing elements associated with sensing of the at least one color from among the plurality of colors. The blocking of wavelengths by periodically switching ON and OFF a receptivity to the incident light of the one or more pixels of the display panel may be performed as explained with reference to FIG. 3.

At 804, the method 800 includes removing motion blur from the captured image frame for the at least one color based on the blocking of the wavelengths associated with the at least one color. At 806, the method 800 includes generating a motion deblurred image frame using the captured image frame with the motion blur removed for the at least one color. The operations at 804 and 806 may be performed as explained with reference to operations 704 and 706 in the method 700 and are not explained again herein. Another method for motion deblurring of image frames is explained with reference to FIG. 9.

FIG. 9 is a flowchart depicting an example method 900 for motion deblurring of image frames, in accordance with another example embodiment. The method 900 depicted in the flow chart may be executed by, for example, the apparatus 200 of FIG. 2.

At 902, the method 900 includes causing blocking of wavelengths associated with at least one color in incident light at pre-defined time intervals during an image frame capture by periodically placing a wavelength bandpass filter in a path of the incident light and retracting the wavelength bandpass filter from the path of the incident light during the image frame capture. The blocking of wavelengths by periodically placing the wavelength bandpass filter in a path of the incident light and retracting the wavelength bandpass filter from the path of the incident light during the image frame capture may be performed as explained with reference to FIG. 5.

At 904, the method 900 includes removing motion blur from the captured image frame for the at least one color based on the blocking of the wavelengths associated with the at least one color. At 906, the method 900 includes generating a motion deblurred image frame using the captured image frame with the motion blur removed for the at least one color. The operations at 904 and 906 may be performed as explained with reference to operations 704 and 706 in the method 700 and are not explained again herein.

It should be noted that to facilitate discussions of the flowcharts of FIGS. 7, 8 and 9, certain operations are described herein as constituting distinct steps performed in a certain order. Such implementations are examples only and non-limiting in scope. Certain operations may be grouped together and performed in a single operation, and certain operations may be performed in an order that differs from the order employed in the examples set forth herein. Moreover, certain operations of the methods 700, 800 and 900 are performed in an automated fashion. These operations involve substantially no interaction with the user. Other operations of the methods 700, 800 and 900 may be performed in a manual fashion or semi-automatic fashion. These operations involve interaction with the user via one or more user interface presentations.

The operations of the flowcharts, and combinations of operation in the flowcharts, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture, the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the methods are described with help of apparatus 200. However, the operations of the methods can be described and/or practiced by using any other apparatus.

Without in any way limiting the scope, interpretation, or application of the claims appearing below, a technical effect of one or more of the example embodiments disclosed herein is to generate motion deblurred image frames. Various embodiments disclose a wavelength based flutter shutter in a camera to remove motion blur in a captured image frame. More specifically, various embodiments disclosed herein suggest subjecting only a band of wavelengths in the incident light (for example, a band of wavelengths associated with a color in incident light) to the flutter shutter effect, instead of the completely closing and opening a shutter of the camera as suggested in conventional techniques. As a result, the light throughput in the captured image frame is higher compared to the conventional flutter shutter based cameras. In addition to the better light throughput, such a technique also precludes several noise and color related artifacts observed in image frames captured in low-light or reduced light conditions.

The techniques disclosed herein may especially be suitable for automotive and other industrial imaging use cases where the scenes can be highly dynamic and it is important to get sharp images for the computer vision modules to work well.

In some embodiments, such wavelength based flutter-shutter operation may be implemented in plenoptic cameras, with one or more views/channels being captured with a flutter shutter effect, while other views/color channels being captured with a conventional or normal exposure. To that effect, a wavelength dependent bandpass filter may be placed in front of each set of lens. Further, a wavelength selective operation may also be suitable for several technologies that sense all the three colors at each sensing element, such as for example a Foveon like camera, as no color interpolation or demosaicing is needed.

In case of multi-spectral sensors, where more bands of wavelengths are captured by the camera, the apparatus 200 may be caused to employ multiple different types of fluttering in different wavelength channels, thereby enabling a better deconvolution of the motion blurred image than a conventional three channel camera sensor.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A non-transitory computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various embodiments are set out in the independent claims, other embodiments comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

We claim:

1. A method comprising:
causing a screening element in a camera to block wavelengths associated with at least one color in incident light at pre-defined time intervals during an image frame capture;
removing motion blur from the captured image frame for the at least one color based on the blocking of the wavelengths associated with the at least one color; and
generating a motion deblurred image frame using the captured image frame with the motion blur removed for the at least one color.

2. The method as claimed in claim 1, wherein the screening element is disposed in a path traveled by the incident light from at least one lens to a sensor in the camera, the sensor comprising a plurality of sensing elements, each sensing element from among the plurality of sensing elements configured to sense, in the incident light, a color from among a plurality of colors associated with a pre-defined color space.

3. The method as claimed in claim 2, wherein the screening element comprises a plurality of pixels in proportion to the plurality of sensing elements of the sensor.

4. The method as claimed in claim 3, wherein a receptivity to the incident light of one or more pixels from among the plurality of pixels is periodically switched ON and OFF during the image frame capture for causing the blocking of the wavelengths associated with the at least one color in the incident light, the one or more pixels related to sensing elements associated with sensing of the at least one color.

5. The method as claimed in claim 1, wherein the screening element is a wavelength bandpass filter disposed in front of at least one lens in the camera, the wavelength bandpass filter capable of being periodically placed in a path of the incident light and retracted from the path of the incident light during the image frame capture to cause the blocking of the wavelengths at the pre-defined time intervals.

6. The method as claimed in claim 1, further comprising:
performing a deconvolution of the captured image frame in the at least one color for removing the motion blur.

7. The method as claimed in claim 1, wherein generating the motion deblurred image frame comprises:
performing content matching for identifying image patches of the captured image frame in other colors that correspond to each image patch of the captured image frame with the motion blur removed for the at least one color; and
transferring sharpness from the each image patch in the at least one color to the corresponding image patches in the other colors.

8. An apparatus comprising:
at least one processor; and
at least one memory comprising computer program code, the at least one memory and the computer program code configured to, with the at least one processor, cause the apparatus to at least perform:
cause a screening element in a camera to block wavelengths associated with at least one color in incident light at pre-defined time intervals during an image frame capture;
remove motion blur from the captured image frame for the at least one color based on the blocking of the wavelengths associated with the at least one color; and
generate a motion deblurred image frame using the captured image frame with the motion blur removed for the at least one color.

9. The apparatus as claimed in claim 8, wherein the screening element is disposed in a path traveled by the incident light from at least one lens to a sensor in the camera, the sensor comprising a plurality of sensing elements, each sensing element from among the plurality of sensing elements configured to sense, in the incident light, a color from among a plurality of colors associated with a pre-defined color space.

10. The apparatus as claimed in claim 9, wherein the screening element comprises a plurality of pixels in proportion to the plurality of sensing elements of the sensor.

11. The apparatus as claimed in claim 10, wherein a receptivity to the incident light of one or more pixels from among the plurality of pixels is periodically switched ON and OFF during the image frame capture for causing the blocking of the wavelengths associated with the at least one color in the incident light, the one or more pixels related to sensing elements associated with sensing of the at least one color.

12. The apparatus as claimed in claim 8, wherein the screening element is a wavelength bandpass filter disposed in front of at least one lens in the camera, the wavelength bandpass filter capable of being periodically placed in a path of the incident light and retracted from the path of the incident light during the image frame capture to cause the blocking of the wavelengths at the pre-defined time intervals.

13. The apparatus as claimed in claim 8, wherein the apparatus is further caused, at least in part to:
perform a deconvolution of the captured image frame in the at least one color for removing the motion blur.

14. The apparatus as claimed in claim 8, wherein the apparatus is further caused, at least in part to:
perform content matching for identifying image patches of the captured image frame in other colors that correspond to each image patch of the captured image frame with the motion blur removed for the at least one color; and
transfer sharpness from the each image patch in the at least one color to the corresponding image patches in the other colors.

15. A computer program product comprising at least one computer-readable storage medium, the computer-readable storage medium comprising a set of instructions, which, when executed by one or more processors, cause an apparatus to at least perform:
cause a screening element in a camera to block wavelengths associated with at least one color in incident light at pre-defined time intervals during an image frame capture;
remove motion blur from the captured image frame for the at least one color based on the blocking of the wavelengths associated with the at least one color; and
generate a motion deblurred image frame using the captured image frame with the motion blur removed for the at least one color.

16. The computer program product as claimed in claim 15, wherein the screening element is disposed in a path traveled by the incident light from at least one lens to a sensor in the camera, the sensor comprising a plurality of sensing elements, each sensing element from among the plurality of sensing elements configured to sense, in the incident light, a color from among a plurality of colors associated with a pre-defined color space.

17. The computer program product as claimed in claim 16, wherein the screening element comprises a plurality of pixels in proportion to the plurality of sensing elements of the sensor.

18. The computer program product as claimed in claim 17, wherein a receptivity to the incident light of one or more pixels from among the plurality of pixels is periodically switched ON and OFF during the image frame capture for causing the blocking of the wavelengths associated with the at least one color in the incident light, the one or more pixels related to sensing elements associated with sensing of the at least one color.

19. The computer program product as claimed in claim 15, wherein the screening element is a wavelength bandpass filter disposed in front of at least one lens in the camera, the wavelength bandpass filter capable of being periodically placed in a path of the incident light and retracted from the path of the incident light during the image frame capture to cause the blocking of the wavelengths at the pre-defined time intervals.

20. The computer program product as claimed in claim 15, wherein the apparatus is further caused, at least in part to:
perform content matching for identifying image patches of the captured image frame in other colors that correspond to each image patch of the captured image frame with the motion blur removed for the at least one color; and
transfer sharpness from the each image patch in the at least one color to the corresponding image patches in the other colors.
